(19) United States
(12) Patent Application Publication
(10) Pub. No.: US 2026/0341039 A1
(43) Pub. Date: Oct. 29, 2026

(54) DRIVING ASSISTANCE DEVICE

(71) Applicant: TOYOTA JIDOSHA KABUSHIKI KAISHA, Aichi (JP)

(72) Inventor: Kazuki FUKAZAWA, Toyota-shi (JP)

(21) Appl. No.: 19/645,294

(22) Filed: Apr. 13, 2026

(30) Foreign Application Priority Data
Apr. 23, 2025 (JP) 2025-071192

(51) Int. Cl. G06V 20/58; G06T 5/50; G06T 7/11

(52) U.S. Cl. CPC G06V 20/58; G06T 5/50; G06T 7/11; G06T 2207/20221; G06V 2201/07

(57) ABSTRACT

A processor of a driving assistance device divides, among a surrounding image G, an area corresponding to an object-detectable area into a plurality of sections, superimposes and displays an object detection image on a first section among the plurality of sections, and, when the object detection image is not superimposed and displayed on all sections adjacent to the first section, assigns a standard value to a transparency of the object detection image to be superimposed and displayed on the first section, and, when the object detection image is superimposed and displayed on the first section and at least one section adjacent to the first section, assigns a value higher than the standard value to a transparency of each of these object detection images.

### BACKGROUND

The present invention relates to a driving assistance device including a camera for capturing a surrounding area of an own vehicle to acquire a surrounding image and an object detection sensor for acquiring information relating to a position of a three-dimensional object present within the surrounding area, and having a function of superimposing and displaying, on the surrounding image, the information relating to the position of the three-dimensional object acquired by the object detection sensor.

### DESCRIPTION OF THE RELATED ART

A driving assistance device has been proposed that includes a camera for capturing a surrounding area of an own vehicle to acquire a surrounding image (G) and an object detection sensor for acquiring a position of a three-dimensional object present within the surrounding area, and has a function of superimposing and displaying, on the surrounding image, information relating to the position of the three-dimensional object acquired by the object detection sensor (see, for example, Patent Document 1 below). This driving assistance device (hereinafter referred to as a “conventional device”) has a function of, when a three-dimensional object is not detected by the object detection sensor, superimposing and displaying, on the surrounding image, an image indicating a detectable range of the object detection sensor.

### PATENT DOCUMENTS

Patent Document 1: Japanese Unexamined Patent Application Publication No. 2008-186132

### SUMMARY

Incidentally, in order to call attention of a driver of an own vehicle to a three-dimensional object located near the own vehicle, there is a case where a driving assistance device is configured such that an image indicating a detection result of an object detection sensor (object detection image) is superimposed and displayed on a predetermined area of a surrounding image (an area corresponding to a position (direction) of the three-dimensional object acquired by the object detection sensor). For example, among the surrounding image, a predetermined section in a direction in which the three-dimensional object is present is filled in “yellow” or “red.” In this case, since a part of the surrounding image is covered and hidden by the object detection image, there is a possibility that the driver may have difficulty visually recognizing an image of the corresponding part of the surrounding image (a photograph acquired by the camera (for example, a photograph of the three-dimensional object itself and a white line drawn on a road surface around the three-dimensional object)).

One of objects of the present invention is to provide a driving assistance device having a function of superimposing and displaying information acquired by an object detection sensor on a surrounding image indicating surroundings of an own vehicle, the driving assistance device having a function of displaying the information in an appropriate manner according to a situation.

In order to achieve the above object, the driving assistance device (1) of the present invention includes:
an in-vehicle sensor (20) including a camera (22) for acquiring a surrounding image (G) which is an image of a surrounding area of an own vehicle and an object detection sensor (21) for acquiring information relating to a position of a three-dimensional object present in a predetermined object-detectable area (D) within the surrounding area;
a display device (30) for displaying an image; and
a processor (10) configured to control the display device such that an object detection image(S) indicating a detection result of the three-dimensional object is superimposed and displayed on, among an entire area of the surrounding image, an area corresponding to a position of the three-dimensional object detected by the object detection sensor.

The processor:
divides, among the surrounding image, an area (R) corresponding to the object-detectable area into a plurality of sections (Bk);
when the object detection image is superimposed and displayed on a first section among the plurality of sections, and the object detection image is not superimposed and displayed on all sections adjacent to the first section, assigns a standard value (T0) to a transparency (T) of the object detection image to be superimposed and displayed on the first section; and
when the object detection image is superimposed and displayed on the first section and at least one section adjacent to the first section, assigns a value (T1) higher than the standard value to a transparency of each of these object detection images.

When a three-dimensional object is detected by the object detection sensor, when an object detection image as a detection result is superimposed and displayed on a surrounding image, a part of the surrounding image is covered by the object detection image, and thus there is a possibility that a driver may have difficulty visually recognizing an image of the part (a part of the surrounding image). Here, in order to solve this problem, when a transparency of the object detection image is uniformly increased, there is a possibility that the driver may have difficulty recognizing that the object detection image is displayed. Therefore, when superimposing and displaying the object detection image on the surrounding image, a processor of the driving assistance device according to the present invention adjusts a transparency of each object detection image according to a situation. That is, in a first situation in which the processor superimposes and displays the object detection image on a first section (section B2 in an example of FIG. 2) of the surrounding image and does not superimpose and display the object detection image on all sections adjacent to the first section (sections B1 and B3 in the example of FIG. 2), the processor assigns a standard value (a value having a relatively low transparency) to a transparency of the object detection image of the first section. On the other hand, in a second situation in which the processor superimposes and displays the object detection image on a first section (section B2 in an example of FIG. 3) of the surrounding image and also superimposes and displays the object detection image on at least one section (section B3 in the example of FIG. 3) adjacent to the first section, the processor assigns, to a transparency of each of these object detection images, a value higher than the standard value. In the first situation, since the transparency of the object detection image is relatively low, the object detection image is easily noticeable. That is, it is possible to call attention of the driver to the three-dimensional object in a direction of the object detection image. In the first situation, the driver may have some difficulty visually recognizing an image of an inner portion of the first section in the surrounding image; however, since a range thereof is relatively narrow, the driver can predict the inner portion of the first section from images around the first section. In contrast, in the second situation, since the transparency of the object detection images is relatively high, the driver can easily visually recognize, among the surrounding image, images of portions covered by these object detection images. In the second situation, compared to the first situation, the object detection images are less noticeable; however, since a plurality of object detection images are disposed adjacent to each other (an area occupied by the object detection images in the surrounding image is relatively large), even when the transparency of these object detection images is relatively high, the driver can recognize that the object detection images are displayed. As described above, according to the present invention, it is possible to provide a driving assistance device having a function of superimposing and displaying information acquired by an object detection sensor on a surrounding image indicating surroundings of an own vehicle, the driving assistance device having a function of displaying the information in an appropriate manner according to a situation.

In a driving assistance device according to one embodiment of the present invention,
the surrounding image corresponds to a plan view in which an own vehicle and a surrounding portion thereof are viewed from directly above, and
the plurality of sections correspond to a plurality of regions obtained by dividing, in a circumferential direction, an annular region surrounding the own vehicle in the surrounding image.

According to this, the driver can easily grasp a positional relationship between the own vehicle and the three-dimensional object (a direction of the three-dimensional object as viewed from the own vehicle).

In a driving assistance device according to another embodiment of the present invention,
the processor is configured to:
when the object detection image is superimposed and displayed on the first section, the object detection image is superimposed and displayed on a second section adjacent to the first section on one side of the first section, and the object detection image is not superimposed and displayed on a third section adjacent to the first section on the other side of the first section, assign a first value higher than the standard value to a transparency of each of these object detection images; and
when the object detection image is superimposed and displayed on the first section, the object detection image is superimposed and displayed on the second section, and the object detection image is superimposed and displayed on the third section, assign a second value higher than the first value to a transparency of each of these object detection images.

When the number of object detection images arranged adjacent to each other is three (Situation A), there is a possibility that visibility of the surrounding image may be reduced as compared to a case where the number of object detection images arranged adjacent to each other is two (Situation B). According to the driving assistance device of this embodiment, a transparency of the object detection images in Situation A is set higher than a transparency of the object detection images in Situation B. Thus, reduction in visibility of the surrounding image is suppressed. Note that a display area of the object detection images in Situation A is larger than a display area of the object detection images in Situation B. Therefore, even when the transparency of the object detection images in Situation A is higher than the transparency of the object detection images in Situation B, the driver can recognize that the object detection images are displayed.

In a driving assistance device according to another embodiment of the present invention,
the object detection sensor includes a positioning sensor that emits light, radio waves, or ultrasonic waves outward from a peripheral end surface of an own vehicle and detects a three-dimensional object based on a reflected wave thereof.

According to this, using a well-known sensor, it is possible to relatively easily acquire a position of the three-dimensional object with respect to the own vehicle.

In a driving assistance device according to another embodiment of the present invention,
the object detection image is a figure having the same shape and the same size as the section including a region in which reflection points, at which the emitted radio waves, light, or ultrasonic waves are reflected, are distributed.

In the driving assistance device of this embodiment, among a plurality of sections provided in the surrounding image, a section corresponding to a position (direction) of a detected three-dimensional object is filled in. Thus, the driver can grasp an approximate position (direction) of the three-dimensional object with respect to the own vehicle.

### BRIEF DESCRIPTION OF THE DRAWINGS

FIG. 1 is a block diagram of a driving assistance device according to one embodiment of the present invention.

FIG. 2 is an example of an image displayed on an image display device when one pedestrian is present diagonally forward to the right of an own vehicle.

FIG. 3 is an example of an image displayed on the image display device when two pedestrians are present diagonally forward to the right of the own vehicle.

FIG. 4 is a flowchart of a program executed by a CPU in order to realize an attention calling function.

### DESCRIPTION OF THE EMBODIMENTS

### Outline

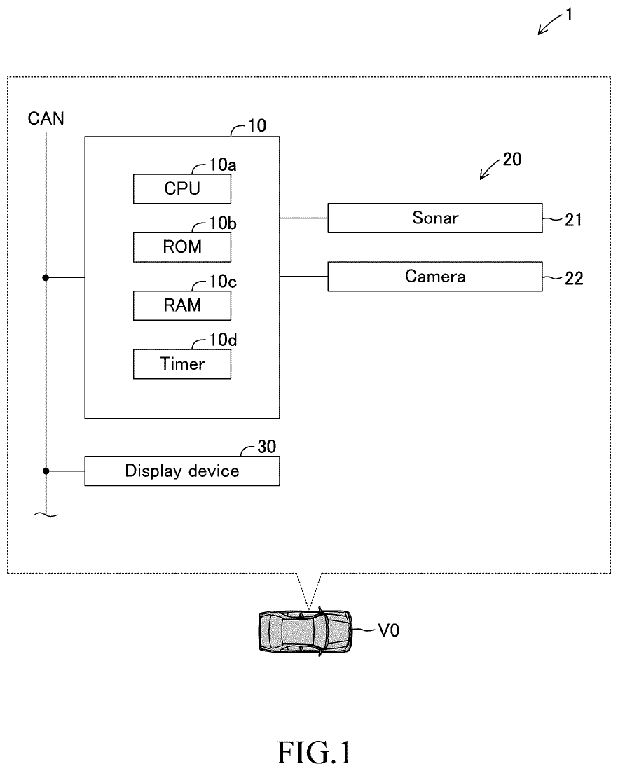

As shown in FIG. 1, a driving assistance device 1 according to one embodiment of the present invention is applied to a vehicle V0 (hereinafter referred to as an “own vehicle”). The own vehicle has an autonomous driving function. The driving assistance device 1 has a function (attention calling function) of, in a situation where the autonomous driving function of the own vehicle is disabled and a driver is performing a manual driving operation, calling attention of the driver to a detected object by superimposing and displaying information acquired by an object detection sensor mounted on the own vehicle on an image acquired by a camera mounted on the own vehicle.

### Specific Configuration

Next, a configuration of the driving assistance device 1 will be specifically described. As shown in FIG. 1, the driving assistance device 1 includes an ECU 10, an in-vehicle sensor 20, and an image display device 30.

The ECU 10 includes a microcomputer including a CPU 10a, a ROM 10b, a RAM 10c, a timer 10d, and the like. The ECU 10 is connected to other ECUs via a CAN (communication network).

An in-vehicle sensor 20 includes a sonar 21 as an object detection sensor (positioning sensor) for acquiring information relating to a three-dimensional object OBx (x=a, b, . . . ) located around an own vehicle. The in-vehicle sensor 20 also includes a camera 22 for acquiring an image of a surrounding area of the own vehicle.

The sonar 21 includes a plurality of transmitting/receiving units. The transmitting/receiving units are, for example, incorporated into a front end surface, side surfaces, and a rear end surface of the own vehicle. Each transmitting/receiving unit emits ultrasonic waves to a surrounding area (a front side, a right side, a left side, and a rear side) of the own vehicle, and receives ultrasonic waves (reflected waves) reflected by a three-dimensional object (for example, another vehicle parked in a parking spot adjacent to a parking spot in which the own vehicle is parked, or a pedestrian located near the parking spot in which the own vehicle is parked) present within these emission ranges. The sonar 21 further includes a signal processing unit. The signal processing unit provides, to the ECU 10 as three-dimensional object information, information indicating each region in which reflection points of the ultrasonic waves are distributed (a region occupied by each three-dimensional object OBx around the own vehicle) based on a time from when the transmitting/receiving unit emits the ultrasonic waves until the transmitting/receiving unit receives the reflected waves.

Here, an object-detectable area of the sonar 21 has a band shape (an oblong shape) surrounding the own vehicle in a plan view.

The camera 22 includes an imaging device. The imaging device incorporates, for example, an image sensor such as a CCD (charge coupled device) or a CIS (CMOS image sensor). The imaging device is installed, for example, at a front end portion, a right end portion, a left end portion, and a rear end surface of the own vehicle. Each imaging device captures, at a predetermined frame rate, a front area, a right area, a left area, and a rear area of the own vehicle, respectively, to acquire images (image data). Each imaging device provides the acquired images to the ECU 10.

An image display device 30 acquires an image display command from the ECU 10 and displays an image in accordance with the command.

### Attention Calling Function

The ECU 10 successively acquires three-dimensional object information from the sonar 21. The ECU 10 also successively acquires, from each imaging device of the camera 22, images obtained by capturing a front area, a rear area, a left area, and a right area, and synthesizes (deforms) these images to generate (acquire) a plan view (hereinafter referred to as a “surrounding image G”) which is an image in which a surrounding area of the own vehicle is viewed from directly above.

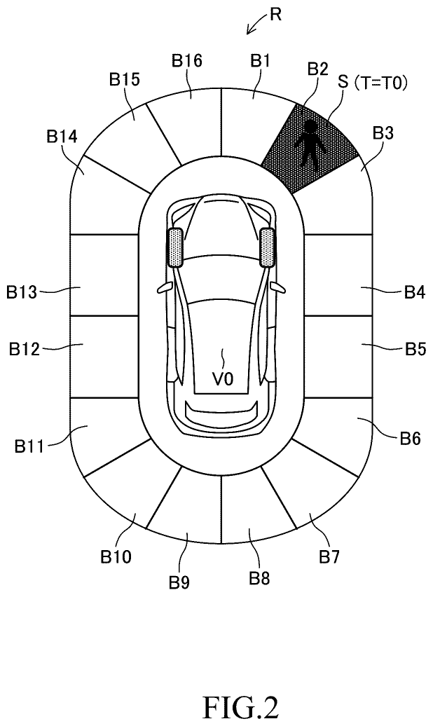

In order to call attention of the driver to the three-dimensional object OBx (x=a, b, . . . ) detected by the sonar 21, the ECU 10 controls the image display device 30 such that a predetermined figure S (object detection image) indicating the detection result is superimposed and displayed on the surrounding image G. Specifically, as shown in FIG. 2, in the surrounding image G, an area R corresponding to the object-detectable area of the sonar 21 is set. As described above, the object-detectable area has an oblong annular (band) shape in a plan view. Therefore, the area R also has an oblong annular shape. The area R is equally divided, in a circumferential direction thereof, into a plurality of sections (angle ranges). For example, as shown in FIG. 2, the area R is divided into 16 sections (sections B1 to B16). The ECU 10 controls the image display device 30 such that, among the sections Bk (k=1, 2, . . . , 16), a figure S having the same shape and the same size as the section Bk is superimposed and displayed on a section Bk corresponding to a detection result of the sonar 21 (a region occupied by the three-dimensional object OBx) (a section Bk corresponding to a position (direction) of the three-dimensional object OBx) (such that an inside of the section Bk is filled in).

Here, when the figure S is superimposed and displayed on a section Bk (k=1, 2, . . . , 16) in the surrounding image G, the figure S is displayed in a transparent manner (made semi-transparent) so that a driver can visually recognize an inner portion of the section Bk (a part of a photograph acquired by the camera 22). Here, when a relatively low value is assigned to a transparency T of the figure S so that the figure S is noticeable, an effect of calling attention to the driver is increased; however, visibility of a portion of the surrounding image G covered by the figure S (the inner portion of the section Bk) is reduced.

Therefore, as described below, the ECU 10 adjusts the transparency T of the figure S according to a situation (transparency adjustment processing).

In a situation where three-dimensional objects are unevenly distributed in a relatively narrow range, or a situation where a relatively small three-dimensional object exists alone, the driver has difficulty noticing the three-dimensional object. Therefore, in this situation, the ECU 10 assigns a standard value T0 to the transparency T of the figure S. On the other hand, in a situation where three-dimensional objects exist over a relatively wide range, or a situation where a relatively large three-dimensional object exists, the driver is likely to notice the three-dimensional object. Therefore, in this situation, the ECU 10 assigns a value T1 higher than the standard value T0 to the transparency T of the figure S.

More specifically, as shown in FIG. 2, when the ECU 10 superimposes and displays the figure S on the section Bk of the area R and does not superimpose and display the figure S on a section Bkcw adjacent to the section Bk on a clockwise side thereof and a section Bkccw adjacent to the section Bk on a counterclockwise side thereof, the ECU 10 assigns a standard value T0 to the transparency T of the figure S to be superimposed and displayed on the section Bk. That is, when a three-dimensional object exists in an area corresponding to the section Bk and three-dimensional objects do not exist in areas corresponding to the sections Bkcw and Bkccw on both sides thereof, the transparency T of the figure S superimposed and displayed on the section Bk is adjusted such that the section Bk is relatively noticeable in the surrounding image G (such that the driver can easily recognize the figure S).

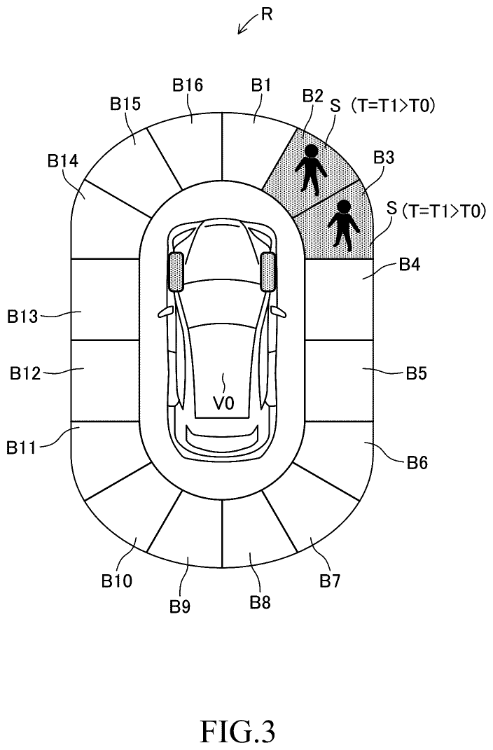

On the other hand, as shown in FIG. 3, when the ECU 10 superimposes and displays the figure S on the section Bk and also superimposes and displays the figure S on at least one of the sections Bkcw and Bkccw, the ECU 10 assigns, to the transparency T of the figure S to be superimposed and displayed on these sections, a value T1 higher than the standard value T0. That is, when three-dimensional objects exist in areas corresponding to a plurality of sections Bk continuous in a circumferential direction of the area R, the transparency T of the figure S is adjusted such that the driver can relatively easily visually recognize images of inner portions of these sections Bk.

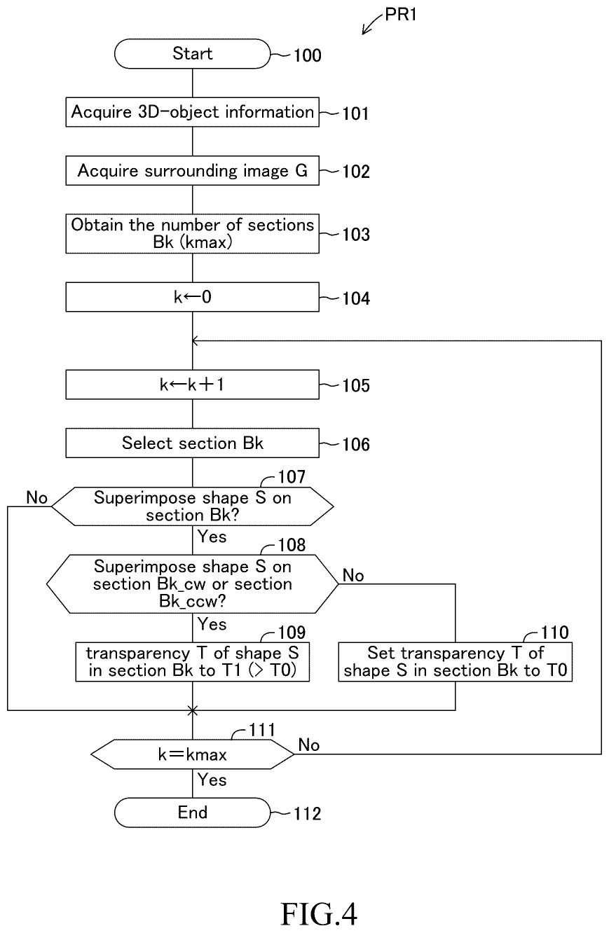

Next, with reference to FIG. 4, a program PR1 executed by the CPU 10a (hereinafter simply referred to as a “CPU”) in order to realize the above-described function of the driving assistance device 1 (a function of setting the transparency T of the figure S according to a situation) will be described. The CPU executes the program PR1 in a predetermined scene. Specifically, based on information acquired from the camera 22, the CPU starts executing the program PR1 at a predetermined cycle in a state where a frame line of a parking spot is detected (a state where there is a high possibility that the own vehicle is parked in the parking spot).

### Program PR1

The CPU starts execution of the program PR1 from step 100 and proceeds to step 101.

In step 101, the CPU acquires three-dimensional object information from the sonar 21. Next, the CPU proceeds to step 102.

In step 102, the CPU acquires images obtained by capturing a front area, a rear area, a left area, and a right area from each imaging device of the camera 22, synthesizes (deforms) these images, and generates (acquires) the surrounding image G. Next, the CPU proceeds to step 103.

In step 103, the CPU acquires the number kmax of sections Bk. In the examples shown in FIGS. 2 and 3, the number kmax is “16.” Next, the CPU proceeds to step 104.

In step 104, the CPU initializes an index k used for selecting (specifying) a section to be processed (a section to be subjected to processing including steps 107 to 110 described below) to “0 .” Next, the CPU proceeds to step 105.

In step 105, the CPU increments the index k. Next, the CPU proceeds to step 106.

In step 106, the CPU selects the section Bk as a processing target. Next, the CPU proceeds to step 107.

In step 107, the CPU determines whether to superimpose and display the figure S on the section Bk. That is, based on the three-dimensional object information, the CPU determines whether a three-dimensional object exists in an area corresponding to the section Bk. When the CPU determines to superimpose and display the figure S on the section Bk (107: Yes), the CPU proceeds to step 108. On the other hand, when the CPU does not determine to superimpose and display the figure S on the section Bk (107: No), the CPU proceeds to step 111.

In step 108, the CPU determines whether to superimpose and display the figure S on at least one of a section Bkcw and a section Bkccw adjacent to the section Bk. That is, based on the three-dimensional object information, the CPU determines whether a three-dimensional object exists in at least one of an area corresponding to the section Bkcw and an area corresponding to the section Bkccw. When the CPU determines to superimpose and display the figure S on at least one of the section Bkcw and the section Bkccw adjacent to the section Bk (108: Yes), the CPU proceeds to step 109. On the other hand, when the CPU does not determine to superimpose and display the figure S on at least one of the section Bkcw and the section Bkccw adjacent to the section Bk (108: No), the CPU proceeds to step 110.

In step 109, the CPU assigns a value T1 higher than a standard value T0 to the transparency T of the figure S to be superimposed and displayed on the section Bk. Next, the CPU proceeds to step 111.

In step 110, the CPU assigns the standard value T0 to the transparency T of the figure S to be superimposed and displayed on the section Bk. Next, the CPU proceeds to step 111.

In step 111, the CPU determines whether the index k matches the number kmax of the sections Bk. When the CPU determines that the index k matches the number kmax (111: Yes), the CPU proceeds to step 112. On the other hand, when the CPU does not determine that the index k matches the number kmax (111: No), the CPU returns to step 105.

In step 112, the CPU ends execution of the program PR1.

### Effects

When a three-dimensional object is detected by the sonar 21, when the figure S as a detection result is superimposed and displayed on the surrounding image G, a part of the surrounding image G is covered by the figure S, and thus there is a possibility that a driver may have difficulty visually recognizing an image of the part (a part of the surrounding image G). Here, in order to solve this problem, when the transparency T of the figure S is uniformly increased, there is a possibility that the driver may have difficulty recognizing that the figure S is displayed. Therefore, when superimposing and displaying the figure S on the surrounding image G, the ECU 10 of the driving assistance device 1 according to the present embodiment adjusts the transparency T of each figure S according to a situation. That is, in a first situation in which the ECU 10 superimposes and displays the figure S on a first section (section B2 in the example of FIG. 2) of the surrounding image G and does not superimpose and display the figure S on all sections adjacent to the first section (sections B1 and B3 in the example of FIG. 2), the ECU 10 assigns a standard value T0 (a value having a relatively low transparency) to the transparency T of the figure S of the first section. On the other hand, in a second situation in which the ECU 10 superimposes and displays the figure S on a first section (section B2 in the example of FIG. 3) of the surrounding image G and also superimposes and displays the figure S on at least one section (section B3 in the example of FIG. 3) adjacent to the first section, the ECU 10 assigns, to the transparency T of each of these figures S, a value T1 higher than the standard value T0. In the first situation, since the transparency T of the figure S is relatively low, the figure S is easily noticeable. That is, it is possible to call attention of the driver to a three-dimensional object in a direction of the figure S. In the first situation, the driver may have some difficulty visually recognizing an image of an inner portion of the first section in the surrounding image G; however, since a range thereof is relatively narrow, the driver can predict the inner portion of the first section from images around the first section. In contrast, in the second situation, since the transparency T of the figures S is relatively high, the driver can easily visually recognize, among the surrounding image G, images of portions covered by these figures S. In the second situation, compared to the first situation, the figures S are less noticeable; however, since a plurality of figures S are disposed adjacent to each other (an area occupied by the figures S in the surrounding image G is relatively large), even when the transparency T of these figures S is relatively high, the driver can recognize that the figures S are displayed. As described above, according to the present embodiment, it is possible to provide a driving assistance device including a function of superimposing and displaying information acquired by the sonar 21 on the surrounding image G indicating surroundings of an own vehicle, the driving assistance device including a function of displaying the figures S in an appropriate manner (transparency) according to a situation.

### Modification 1

In the above embodiment, when the figures S are superimposed and displayed on a plurality of sections Bk continuous in a circumferential direction of the area R, a value T1 higher than the standard value T0 is assigned to the transparency T of these figures S. That is, when the figures S are respectively superimposed and displayed on two or more sections Bk continuous in a circumferential direction of the area R, regardless of the number of the figures S continuously arranged in the circumferential direction of the area R, the transparency T of the figures S is uniform (T1>T0). Instead of this, when the figures S are respectively superimposed and displayed on two or more sections Bk continuous in the circumferential direction of the area R, a higher value may be assigned to the transparency T of these figures S as the number of the figures S continuously arranged increases. That is, for example, when the ECU 10 superimposes and displays the figures S on the sections B2 and B3 and does not superimpose and display the figure S on the section B1, the ECU 10 assigns, to the transparency T of these figures S, a first value T1 (for example, “30%”) higher than the standard value T0 (for example, “20%”). In addition, for example, when the ECU 10 superimposes and displays the figures S on the sections B1, B2, and B3, the ECU 10 assigns, to the transparency T of these figures S, a second value T2 (for example, “40%”) higher than the first value T1.

### Modification 2

A color of the figure S may be set according to a distance Δd between a three-dimensional object detected by the sonar 21 and an own vehicle. For example, when the distance Δd exceeds a threshold value Δdth, the color of the figure S may be set to “yellow,” and when the distance Δd is equal to or less than the threshold value Δdth, the color of the figure S may be set to “red.”

### Modification 3

Instead of (or in addition to) the sonar 21, a LiDAR may be used which emits laser light to a surrounding area of an own vehicle and detects a three-dimensional object located around the own vehicle based on reflected light thereof. In addition, instead of (or in addition to) the sonar 21, a millimeter-wave radar may be used which emits millimeter-wave radio waves to a surrounding area of the own vehicle and detects a three-dimensional object located around the own vehicle based on a reflected wave thereof.

### Modification 4

In the above embodiment, an object-detectable area of the sonar 21 (object detection sensor) extends over an entire circumference of the own vehicle. Instead of this, the object-detectable area of the sonar 21 may not extend over an entirety of the own vehicle and may be limited to a predetermined area. For example, the sonar 21 may be incapable of detecting a three-dimensional object located on a side of the own vehicle (for example, sections B4, B5, B12, and B13 in FIGS. 2 and 3).

What is claimed is:

1. A driving assistance device comprising:
a camera for acquiring a surrounding image which is an image of a surrounding area of an own vehicle, and an in-vehicle sensor including an object detection sensor for acquiring information relating to a position of a three-dimensional object present in a predetermined object-detectable area within the surrounding area;
a display device for displaying an image; and
a processor configured to control the display device such that an object detection image indicating a detection result of the three-dimensional object is superimposed and displayed on, among an entire area of the surrounding image, an area corresponding to the position of the three-dimensional object detected by the object detection sensor, wherein
the processor is configured to:
divide, among the surrounding image, an area corresponding to the object-detectable area into a plurality of sections;
when the object detection image is superimposed and displayed on a first section among the plurality of sections, and the object detection image is not superimposed and displayed on all sections adjacent to the first section, assign a standard value to a transparency of the object detection image to be superimposed and displayed on the first section; and
when the object detection image is superimposed and displayed on the first section and at least one section adjacent to the first section, assign a value higher than the standard value to a transparency of each of the object detection images to be superimposed and displayed on the first section and the at least one section adjacent to the first section.

2. A driving assistance device according to claim 1,
wherein the surrounding image corresponds to a plan view in which an own vehicle and a surrounding portion thereof are viewed from directly above, and
the plurality of sections correspond to a plurality of regions obtained by dividing, in a circumferential direction, an annular region surrounding the own vehicle in the surrounding image.

3. A driving assistance device according to claim 2,
wherein the processor is configured to:
when the object detection image is superimposed and displayed on the first section, the object detection image is superimposed and displayed on a second section adjacent to the first section on one side of the first section, and the object detection image is not superimposed and displayed on a third section adjacent to the first section on the other side of the first section, assign a first value higher than the standard value to a transparency of each of these object detection images; and
when the object detection image is superimposed and displayed on the first section, the object detection image is superimposed and displayed on the second section, and the object detection image is superimposed and displayed on the third section, assign a second value higher than the first value to a transparency of each of these object detection images.

4. A driving assistance device according to claim 1,
wherein the object detection sensor includes a positioning sensor that emits light, radio waves, or ultrasonic waves outward from a peripheral end surface of the own vehicle and detects the three-dimensional object based on a reflected wave thereof.

5. A driving assistance device according to claim 4,
wherein the object detection image is a figure having the same shape and the same size as the section including a region in which reflection points, at which the emitted radio waves, light, or ultrasonic waves are reflected, are distributed.
